(19) United States
(12) Patent Application Publication
(10) Pub. No.: US 2020/0078979 A1
(43) Pub. Date: Mar. 12, 2020

(54) Adjustable Cutting Fence

(71) Applicant: Kenneth K. Redman, Fredonia, WI (US)

(72) Inventor: Kenneth K. Redman, Fredonia, WI (US)

(21) Appl. No.: 16/562,754

(22) Filed: Sep. 6, 2019

Related U.S. Application Data
(60) Provisional application No. 62/728,222, filed on Sep. 7, 2018.

(51) Int. Cl. B27B 27/10

(52) U.S. Cl. CPC B27B 27/10; B23D 55/04

(57) ABSTRACT

An adjustable fence can be easily and securely attached to the support surface of a boring, drilling or cutting device. The fence includes a base that is releasably attachable to the support surface of the boring, drilling or cutting device adjacent boring, drilling or cutting mechanism. The base includes a pair of brackets located at each end of the base that rotatably support a barrier therebetween. The barrier or fence angle includes a clamping mechanism engageable with each of the brackets on the base in order to releasably secure the fence in the desired position relative to the base. The base also includes a number of stops moveably secured to the fence that can be positioned on the fence angle at the desired location to function as a stop for the movement of the work piece relative to the fence while acted on by the boring, drilling or cutting mechanism.

### CROSS-REFERENCE TO RELATED APPLICATIONS

This application claims priority from U.S. Provisional Patent Application Ser. No. 62/728,222 filed on Sep. 7, 2018, the entirety of which is expressly incorporated herein by reference for all purposes.

### FIELD OF THE DISCLOSURE

The present disclosure relates generally to cutting devices, and more specifically to accessories for deployment on cutting devices to control the shape of cuts made into materials by the cutting device.

### BACKGROUND OF THE DISCLOSURE

In the area of construction, often it is necessary to alter, cut or trim a piece of a construction material, such as wood, among others, in order to properly fit the construction material where necessary or desired. To accomplish this, many different styles and types of boring, drilling and/or cutting implements have been developed.

Some often utilized pieces of boring, drilling and/or cutting equipment include a support surface, such as a table on which the material to be cut can be placed, and a boring, drilling or cutting mechanism disposed on and/or within and extending above the support surface in order to be engageable with the material placed on the support surface. Devices of this type include table saws, band saws and drill presses, among others.

One shortcoming with regard to devices of this type is the lack of the ability to position the material to be cut, bored or drilled on the surface in an orientation other than flat against the support surface. As it is desired on many occasions to alter the construction material in a manner that requires a non-planar or non-perpendicular orientation of the material relative to the cutting, drilling or boring mechanism, it is necessary to modify the support surface in some manner to achieve the desired orientation of the construction material on the support surface prior to engaging the boring, drilling or cutting mechanism with the construction material.

In certain prior art devices, either or both the support surface or the boring, drilling or cutting mechanism is designed to be readily alterable relative to one another. However, the complexity of the constructions of these types of devices render the devices difficult to manufacture and utilize.

Other prior art solutions involve the use of guide that are attachable to the support surface and that can alter the position of the construction material on the support surface as desired. However, these guides normally only enable positioning of the construction material in a single altered orientation, such that multiple guides are required for multiple desired orientations.

Therefore, it is desirable to develop an improved device for altering the position of a piece of construction material with regard to a boring, drilling or cutting mechanism that can address these issues with the prior art.

### SUMMARY OF THE DISCLOSURE

According to one aspect of an exemplary embodiment of the invention, an adjustable fence is provided that can be easily and securely attached to the support surface of a boring, drilling or cutting device. The fence includes a base that is releasably attachable to the support surface of the boring, drilling or cutting device adjacent boring, drilling or cutting mechanism. The base includes a pair of brackets located at each end of the base that rotatably support a fence angle or barrier therebetween. The fence angle includes a clamping mechanism engageable with each of the brackets on the base in order to releasably secure the fence in the desired position relative to the base. The base also includes a number of stops moveably secured to the fence angle that can be positioned on the fence angle at the desired location to function as a stop for the movement of the piece of construction material relative to the fence while being acted on by the boring, drilling or cutting mechanism.

These and other aspects, features and advantages of the invention will be made apparent from the following detailed description taken together with the drawing figures.

### BRIEF DESCRIPTION OF THE DRAWINGS

The drawings illustrate the best mode currently contemplated of practicing the present invention.

In the drawings:

FIG. 1 is an isometric front view of an adjustable fence according to an exemplary embodiment the invention;

FIG. 2 is an isometric rear view of the adjustable fence of FIG. 1;

FIG. 3 is a front elevation view of the adjustable fence of FIG. 1;

FIG. 4 is a top plan view of the adjustable fence of FIG. 1;

FIG. 5 is a left side elevation view of the adjustable fence of FIG. 1;

FIG. 6 is a right side elevation view of the adjustable fence of FIG. 1;

FIG. 7 is a cross-sectional view along line 7-7 of FIG. 4;

FIG. 8 is a cross-sectional view along line 8-8 of FIG. 4;

FIG. 9 is an isometric view of the adjustable fence of FIG. 1 secured to a cutting device in a first configuration;

FIG. 10 is an isometric view of an adjustable stop of the adjustable fence of FIG. 1 in a non-use position;

FIG. 11 is an isometric view of the adjustable fence of FIG. 9 disposed in a second configuration;

FIG. 12 is an isometric view of the adjustable fence of FIG. 9 disposed in a third configuration;

FIG. 13 is an isometric view of the adjustable fence of FIG. 9 disposed in a fourth configuration;

FIG. 14 is an isometric view of the adjustable fence of FIG. 9 disposed in a fifth configuration;

FIGS. 15A-15D are isometric views of the manner of adjustment and/or alignment of the adjustable fence of FIG. 1;

FIG. 16 is a partially broken away, isometric view of a rotational positioning mechanism of the adjustable fence of FIG. 1;

FIG. 17 is an top isometric view of a further exemplary embodiment of the adjustable fence of FIG. 1; and

FIG. 18 is a bottom isometric view of another exemplary embodiment of the adjustable fence of FIG. 1.

### DETAILED DESCRIPTION OF THE DRAWINGS

Before the present compositions, apparatuses and methods are described, it is understood that this invention is not limited to the particular embodiments and methodology, as these may vary. It is also to be understood that the terminology used herein is for the purpose of describing particular exemplary embodiments only, and is not intended to limit the scope of the present invention which will be limited only by the appended claims.

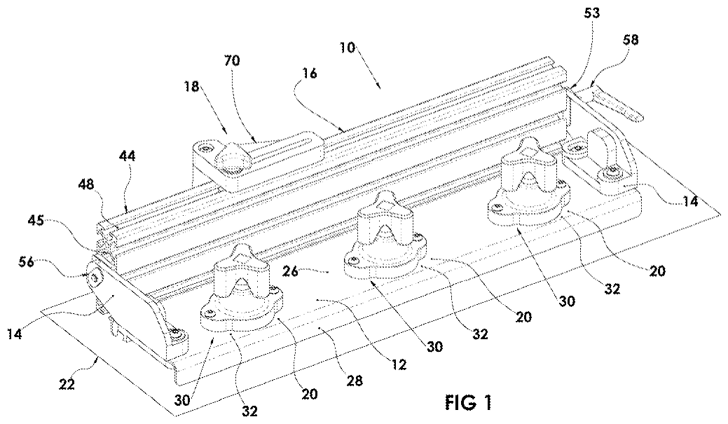

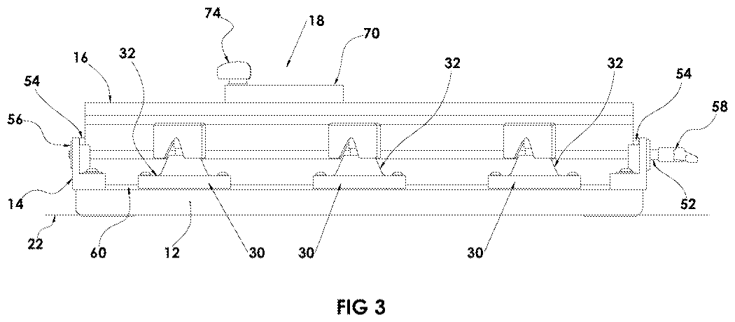

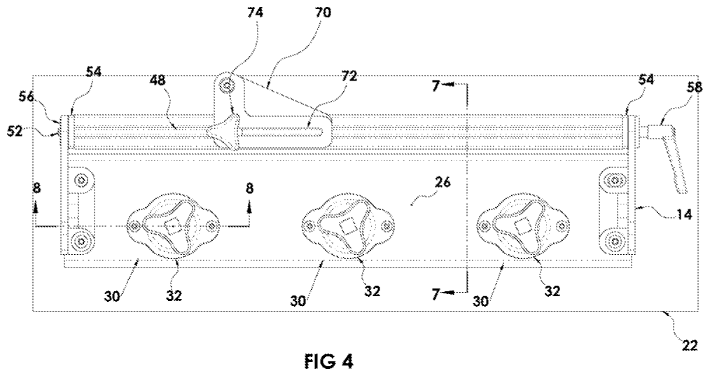

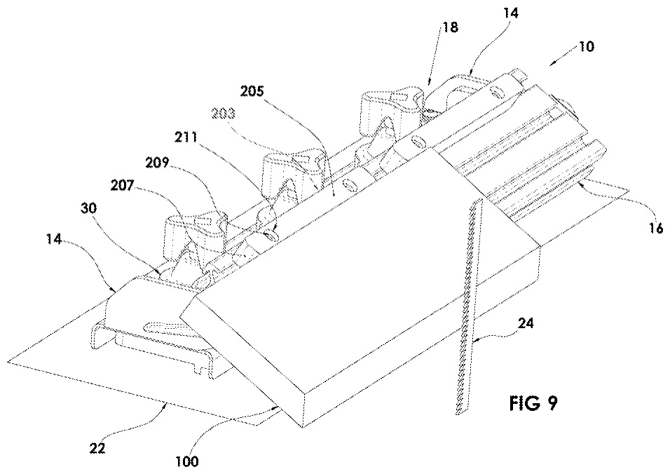

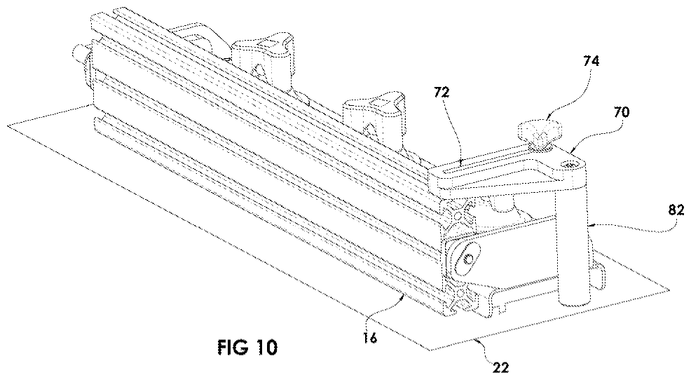

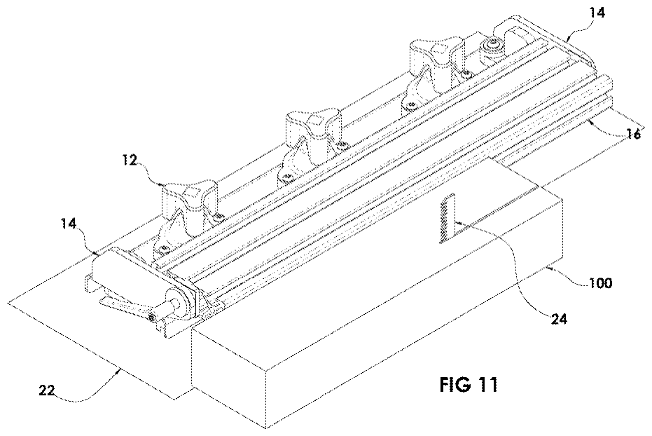

With reference now to FIGS. 1-8 an exemplary embodiment of an adjustable fence is illustrated generally at 10. The fence 10 includes a base 12 and a pair of brackets 14 located at each end of the base 12. Between the brackets 14 is disposed a fence angle or barrier 16 that is rotatable with regard to the brackets 14. The barrier 16 also includes a number of stops 18 that are adjustably positioned on the barrier 16 generally opposite the base 12.

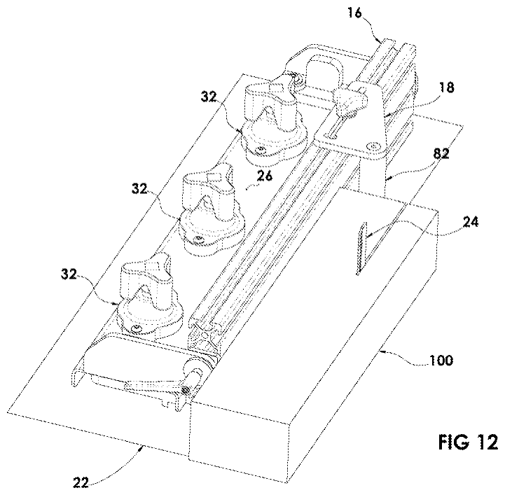

Looking now at FIGS. 1, 3, 4, 7 and 8, the base 12 can be formed of any suitable material, but in the illustrated embodiment is formed from a rigid material, such as a metal or hard plastic material, and includes a securing mechanism 20 disposed thereon. The securing mechanism 20 is able to selectively engage and hold the base 12 securely on a support surface 22 (FIG. 9) of a boring, drilling, cutting or similar device 24. In the illustrated exemplary embodiment, the base 12 is formed with a central portion 26 and a pair of downwardly extending end portions 28 located on each side of the central portion 26 to define an open underside 29, forming a U- or C-channel construction for the base 12. The securing mechanism 20 is formed from a magnetic clamping mechanism 30 including a number of separate clamps 32 disposed on the central portion 26 of the base 12, with examples of the clamps 32 being the Magswitch MagJig manufactured and sold by Mag-Tools of Lafayette, Colo., or the securing mechanism disclosed in co-pending and co-owned U.S. Non-Provisional patent application Ser. No. 16/454,469, entitled Magnetic Clamping Device, the entirety of which is expressly incorporated by reference herein for all purposes, for example. The clamps 32 are positioned within bores 34 in the central portion 26 and are held therein by fasteners 36 inserted though openings 38 in the clamps 32 and engage with aligned apertures 40 in the central portion 26. The bores 34 additionally include sealing members/O-rings 42 disposed around the periphery of the bores 34 and that can be compressed within the bore 34 when the clamp 32 is operated to adjust the space between the clamp 32 and the magnetic or ferritic support surface 22 to effectively magnetically clamp the base 12 to the support surface 22.

Further, the open underside 29 of the base 12 resting on the support surface 22 serves multiple purposes, i.e., to reduce fixture weight and to reduce the potential for wood or metal chips to lodge between the base 12 and the support surface 22.

In other alternative embodiments, the base 12 can be adjustable in length, such that the base 12 can be clamped to any width support surface 22. In this alternative embodiment, the length of the base 12 is adjustable in a known manner to accommodate different width band saw or drill press support surfaces 22. The base 12 includes a clamp (not shown), that can include an adjustable pawl (not shown) located on one end of base 12. The pawl makes contact with the side of the support surface of the band saw or drill press base plate. At opposite end of the base 12 is a hand knob (not shown) with threaded rod, and rubber pad. Turning the knob causes the rubber to advance towards the side of table and apply clamping pressure to hold the base 12 on the support surface 22.

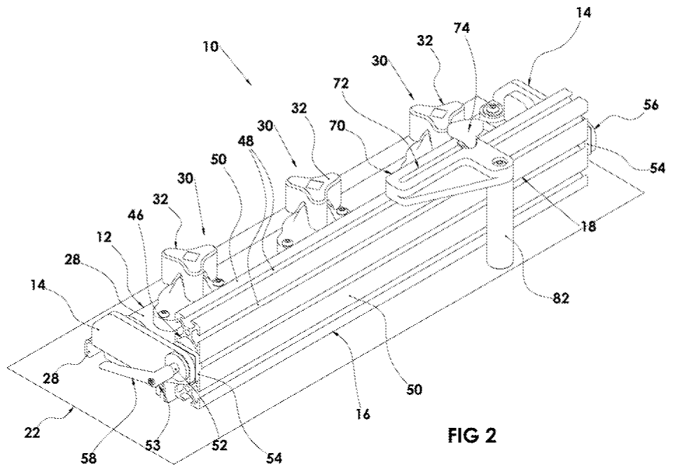

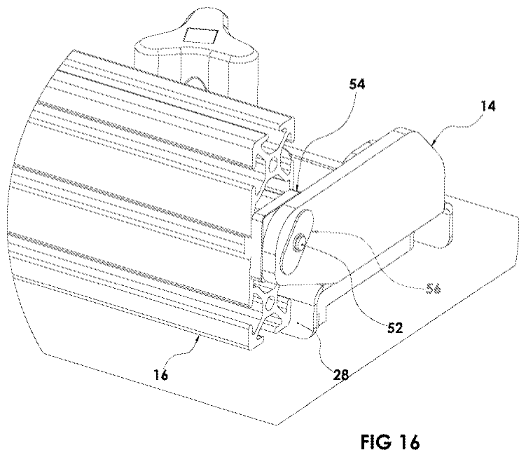

Looking now at FIGS. 2-4, 7, 9 and 16, in the illustrated exemplary embodiment, the barrier 16 is rotatably secured between the brackets 14 attached to the central portion 20 of the base 12. The barrier 16 is formed from a rigid material, such as a metal or hard plastic, such as 6063-T6 Aluminum extrusion 8020, and in the illustrated exemplary embodiment, is formed with an extruded or formed body 44 including a number of central passages 46 extending therethrough and a number of elongate channels 48 located on exterior surfaces 50 thereof. The central passages 46 allow a shaft 52 formed as part of holding mechanism 53 to be inserted though the body 44 and engaged at each end with the brackets 14. As shown particularly in the exemplary embodiment of FIG. 16, one or both ends of the shaft 52 exit the passage 46 in the body 44 and pass through a friction pad 54 disposed between the body 44 of the barrier 16 and the adjacent bracket 14. The friction pads 54 are compressed between the body 44 and the bracket 14 using the holding mechanism 53 to be described to provide a sufficient holding force on the body 44. Each pad 54 is sandwiched between the body/fence 16 and a side support bracket 14. The friction pad 54 is mechanically keyed to fit into passages 46 of the aluminum extrusion forming the barrier 16. The key locks the position of friction pad 54 relative to the fence body 44 so that no sliding between these surfaces can occur.

To enable the shaft 52 to operate as a part of the holding mechanism 53, one end of the shaft 52 extends through the bracket 14 into a collar or weld nut 56 that is secured to, e.g., peened to the shaft 52, and holds the shaft 52 within the bracket 14 to allow for the rotation of the shaft 52 and/or body 44 about the shaft 52 and relative to the brackets 14.

Opposite the collar or weld nut 56, on the end of the shaft 52 is disposed a rotatable, a locking handle 58, such as a threaded ratchet lock handle, also forming a part of the holding mechanism 53. As the ratchet handle 58 is tightened, the right and left hand support brackets 14 flex inward to compress the friction pads 54 against the sides of the body 44. Clamp pressure at both ends of the body 44 creates double the friction force on the body 44 to prevent unwanted rotation of the body 44 relative to the brackets 14. In this manner, the body 44 of the barrier/fence angle 16 can be rotated into any desired angular position with regard to the brackets 14 and fixed in that position through the engagement of the holding mechanism 53 with the body 44.

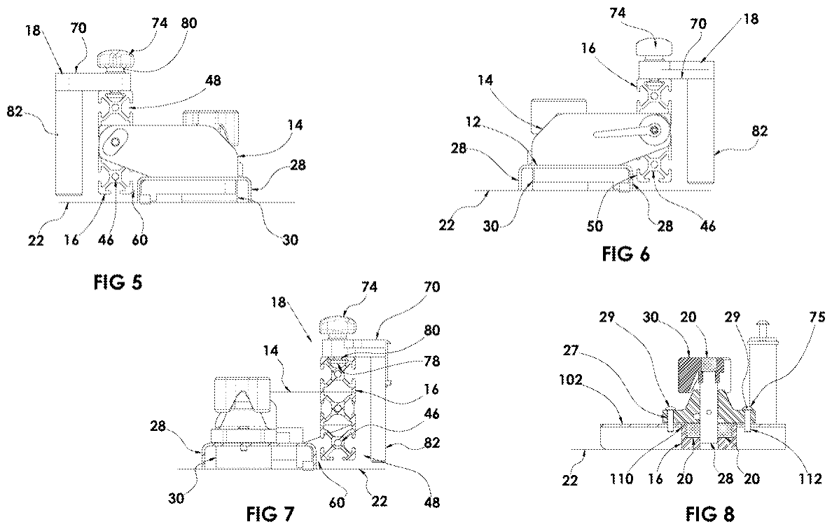

As shown in FIGS. 5-7, The body 44 is held over the base 12 to define a space 60 therebetween that enables chips of the material being cut, drilled, bored, etc., to pass between the body 44 and the base 12 to prevent interference with the construction material, e.g., to insure the work piece 100 can rest fully against the body 44 at all times.

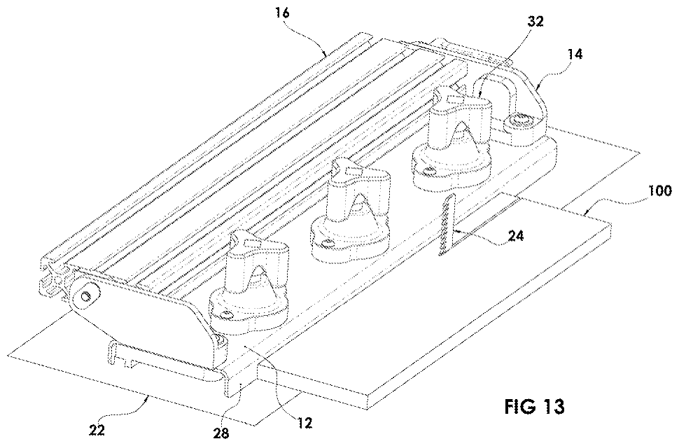

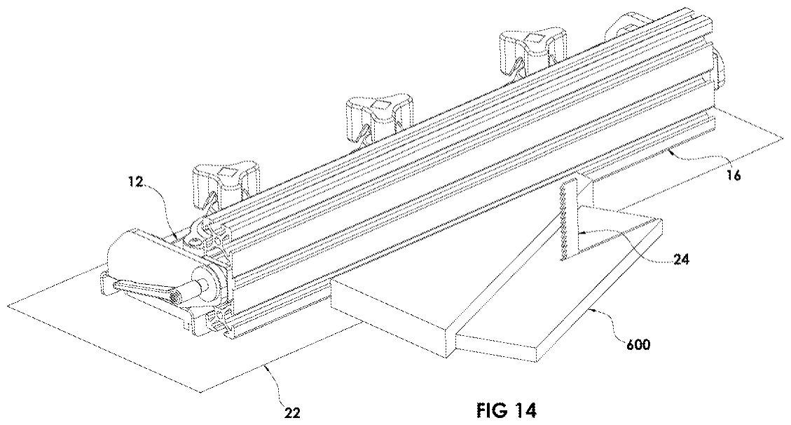

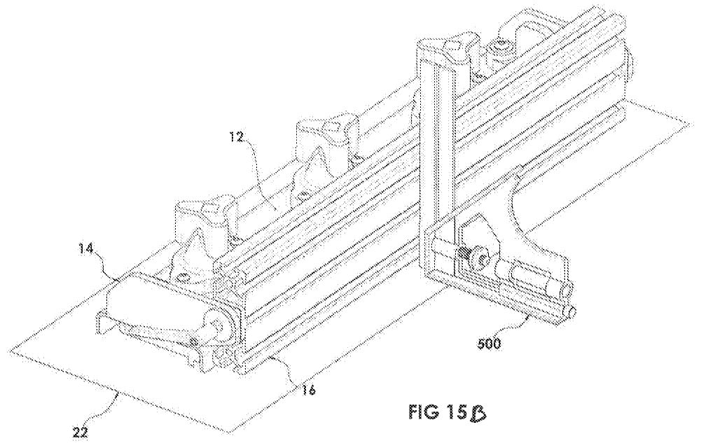

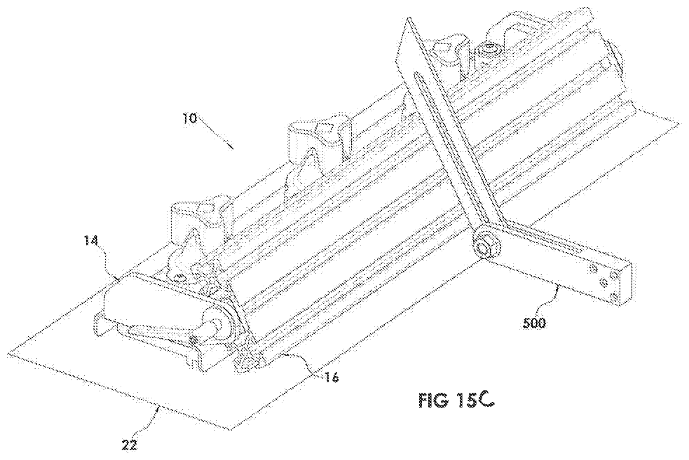

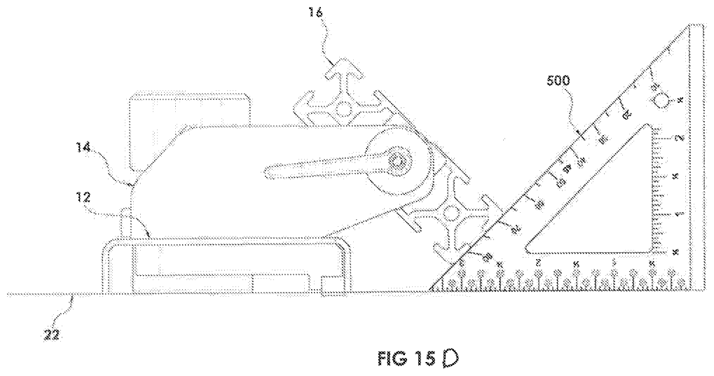

In this construction, the body 44 can rotate from vertical to horizontal orientation relative to the base, as shown in FIGS. 10-11. Further, the angle of the body 44 relative to the support surface 22 can be quickly and precisely set using an implement 500, such as an angle gauge, combination square, engineers square, machinist square, protractor or any other means (FIGS. 15A-15D) to achieve the desired angle for the body 44. In addition, as shown in FIG. 13, the body 44 can be flipped 180 degrees to use the lower side of base 12 as guide on a band saw table, for example, such that, for example, a band saw blade vertical support arm can be lowered in close proximity to thin boards lying flat on support surface 22. Also, a fixture 600 (FIG. 14) can be engaged with the body 44 of the barrier 16 in order to provide the desired angle to the cut formed in the workpiece 100 by the cutting device 24.

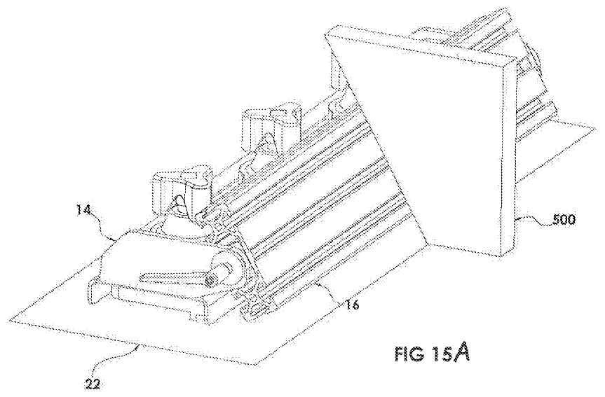

Referring now to FIGS. 1-7, 9, 10 and 12, the one or more stops 18 are secured to the body 44 within a channel 48 located on the body 44. In the illustrated exemplary embodiments, the stops 18 each include a plate 70 having a slot 72 formed therein through which extends a clamping device 74, such as a T-nut 78 and screw 80 (best shown in FIGS. 5-7), to secure the plate 70 to the body 44 at any position along the length of the slot 72 or at any rotational position of the plate 70 relative to the body 44. The screw 80 is movably positioned within a channel 48 in the body 44 to additionally allow the plate 70 to slide along the length of the channel 48 and be secured at the desired location along the channel 48 by engaging the nut 78 with the screw 80. Due to the open ended nature of the channels 48 in the body 44 shown in the exemplary embodiment, the screws 80 can be removed out of the exposed ends of the channels 48 in order to remove the stops 18 from or add additional stops 18 to the body as desired.

Generally opposite the slot 72, the plate 70 includes a post 82 that is secured to and extends downwardly from the plate 70 to overlap the body 44. The post 82 can have any configuration desired and can optionally function as a contour, to enable free hand contours to be cut or formed into the work piece 100, or as a stop for the movement of the work piece 100 relative to the body 44. As a result of the engagement of the screw 80 securing the plate 70 to the body 44 within the channel 48, the plate 70 can be moved forward and back along the full length of body 44 to position and lock the post 82 in the desired position. In addition, the plate 70 and post 82 can be positioned closer to or further away from the working surface of the body 44 as a result of the slots 72. This feature allows the work piece 100 resting against the post to have a variable swing radius during the cutting, drilling or boring operation. Also, the plate 70 and post 82 can be completely pivoted away from the working surface of the body 44, as shown in FIG. 10, allowing an unobstructed body 44 working surface to enable the work piece 100 to slide across the support surface 22, as opposed to competitor work piece stops that only pivot upwards and over the top of fence.

In an alternative embodiment, the one or more stops 18 can be formed as blocks (not shown) that are attached directly to the body 44 to locate the work piece 100 relative to the body 44. The blocks can be formed with one or more cone points (not shown) thereon to be pressed into and engage the work piece 100 directly. In an exemplary embodiment where two or more stop blocks secure a work piece 100 against the body 44, with at least one block on either side of the work piece 100, the fence 10 can be used with magnet clamps 32 deactivated to enable the base 12 with work piece 100 secured thereon being slid or otherwise pushed along the support surface 22 into the cutting blade.

In still another exemplary embodiment of the invention, a ferrous contact plate (not shown) can be utilized with the base 12 and clamps 32 on support surfaces 22 not able to be directly engaged by the base and clamps 32, or to facilitate a wider range of positions for the base 12 relative to the boring, cutting or drilling mechanism on the support surface 22. The ferrous plate includes tabs that are engageable within complementary slots or holes formed within the support surface 22.

The ferrous plate has a flat side that is positioned to face upward in relation to the support surface 22 of band saw, table saw, router, etc., to enable attachment of the base 12 and clamp 32 thereto. The ferrous plate slides across the support surface 22 guided by the plate tabs and integral table top slot. The base 12 can be positioned anywhere on the thin ferrous plate to move closer or further away from the device cutting tool, and-or cut at an angle.

Referring now to FIG. 9, in another exemplary embodiment of the disclosure, a number of guides 203 are disposed within one of the channels 48 of the body 44. Each guide 203 includes a guide member 205 having any desired shape and in the illustrated embodiment is formed as an elongate guide member 205 having a pair of rounded ends 207. The guide member 205 includes a number of attachment members 209 disposed within apertures 211 in the guide member 205. The attachment members 209 are formed similarly to the T-nuts 78 and screws 80 to enable the guide member 205 to be slid along and secured at the desired location along the channels 48. Further, the attachment members 209 are recessed within the apertures 211 to prevent interference with the workpiece 100 on the body 44. When secured to the body 44 of the barrier 16, the guides 203 operate to provide additional support and guidance for longer workpieces 100.

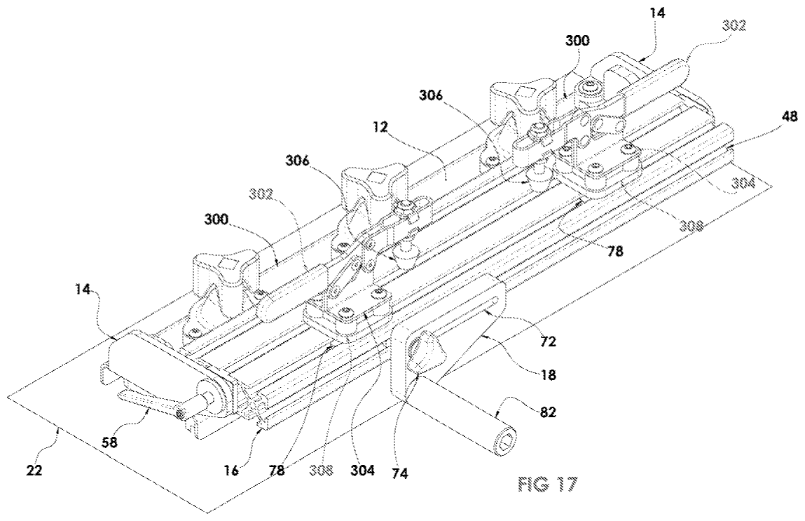

Looking now at FIG. 17, in the illustrated exemplary embodiment a number of clamps 300, such as toggle clamps, are attached to the body 44 of the fence/barrier 16. Each clamp 300 includes a lever arm 302 pivotally secured to a clamp base 304 and to a clamping member 306. The arm 302 is movable between an engaged position where the clamping member 306 is pressed downwardly into engagement with a workpiece 100, and a disengaged position where the clamping member 306 is moved away from the workpiece 100. The clamp base 304 can be secured to one or more channels 48 in the body 44 using T-nuts 78 and screws 80, similar to those for the stops 18, such that the toggle clamps 300 can be moved along and secured to the body 44 (or removed from the body 44 via the ends of the channels 48) where desired. Alternatively, the clamp base 304 can include a riser 308 to raise the position of the clamp base 304 away from the body 44 to extend the clamping range for the toggle clamp 300.

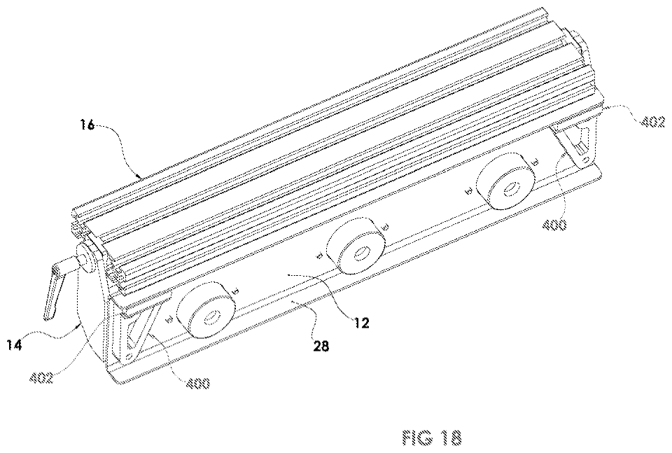

Referring now to FIG. 18, in another alternative embodiment of the disclosure, the base 12 includes one or more retainers 400 disposed on the central portion 26 of the base 12 within the open underside 29. Each retainer 400 directly engages the support surface 22 provides additional frictional force between the base 12 and the support surface 22. In an exemplary embodiment, the retainer 400 can include one or more strips 402 of high friction material, such as a rubber, disposed on the retainer 400 opposite the base 12 to provide the increased frictional force between the base 12 and the support surface 22, or the retainer 400 itself can be formed of a high friction material. The retainer 400 is secured to the central portion 26 within the open underside 29 in any suitable manner to maintain the position of the retainer 400 relative to the base 12 when the base 12 is positioned on the support surface 22.

Various other embodiments of the present invention are contemplated as being within the scope of the filed claims particularly pointing out and distinctly claiming the subject matter regarded as the invention.

We claim:

1. An adjustable fence comprising:
a) a base including a releasable clamping mechanism;
b) a pair of brackets secured to the base; and
c) a barrier rotatably secured between the brackets.

2. The adjustable fence of claim 1 further comprising a positioning mechanism engaged between the barrier and the brackets.

3. The adjustable fence of claim 2 wherein the positioning mechanism comprises:
a) a shaft extending through the barrier;
b) a friction pad disposed around the shaft between the barrier and the bracket; and
c) a locking handle attached to one end of the shaft.

4. The adjustable fence of claim 3 further comprising a pair of friction pads disposed on the shaft between the each end of the barrier the adjacent brackets.

5. The adjustable fence of claim 1 wherein the clamping mechanism is a magnetic clamping mechanism.

6. The adjustable fence of claim 1 wherein the barrier comprises a body having a number of central passages extending therethrough and a number of elongate channels located on exterior surfaces of the body.

7. The adjustable fence of claim 6 further comprising a number of stops connected to the body.

8. The adjustable fence of claim 7 wherein the stop comprises:
a) a plate including a slot formed therein; and
b) a clamping device inserted through the slot and engaged within an elongate channel in the body.

9. The adjustable fence of claim 8 further comprising a post secured to the plate and spaced from the slot.

10. The adjustable fence of claim 8 wherein the plate is pivotally engaged with clamping device.

11. The adjustable fence of claim 8 wherein the clamping mechanism is slidable along the elongate channel.

12. The adjustable fence of claim 6 further comprising a number of guide members engaged with the body.

13. The adjustable fence of claim 12 wherein the guide members are engaged within an elongate channel.

14. The adjustable fence of claim 6 further comprising a number of clamps secured to the body.

15. The adjustable fence of claim 14 wherein the clamp comprises:
a) a clamp base secured to the body; and
b) a clamp arm pivotally attached to the clamp base.

16. The adjustable fence of claim 15 further comprising a riser disposed between the body and the clamp base.

17. The adjustable fence of claim 1 further comprising a retainer secured to the base and frictionally engageable with a support surface on which the base is disposed.

18. The adjustable fence of claim 17 wherein the retainer is at least partially formed of a high friction material.

19. A method for positioning a fence with regard to a cutting implement having a support surface, the method comprising the steps of:
a) providing an adjustable fence comprising:
i) a base including a releasable clamping mechanism;
ii) a pair of brackets secured to the base; and
iii) a body rotatably secured between the brackets;
b) engaging the base with the support surface; and
c) rotating the body relative to the base.

20. The method of claim 19 wherein the adjustable clamp further includes at least one stop connected to the body, and wherein the method further comprises the step of adjusting the position of the at least one stop on the body after rotating the body relative to the base.
